(19) United States
(12) Patent Application Publication
(10) Pub. No.: US 2006/0122337 A1
(43) Pub. Date: Jun. 8, 2006

(54) Polyester amide copolymer, and moldings and production processes of the copolymer

(76) Inventors: Hiroyuki Sato, Fukushima-Ken (JP); Takahiro Watanabe, Fukushima-Ken (JP); Hirokazu Matsui, Ibaraki-Ken (JP); Naoki Ueda, Ibaraki-Ken (JP)

Correspondence Address: WENDEROTH, LIND & PONACK, L.L.P., 2033 K STREET N. W., SUITE 800, WASHINGTON, DC, 20006-1021, US

(21) Appl. No.: 10/540,983

(22) PCT Filed: Dec. 25, 2003
(86) PCT No.: PCT/JP03/16744

§ 371 Date: Jun. 27, 2005

(30) Foreign Application Priority Data
Dec. 27, 2002 (JP) 2002-381269
Dec. 27, 2002 (JP) 2002-381217

(51) Int. Cl. C08G 69/48

(52) U.S. Cl. 525/419; 528/272

(57) ABSTRACT

A polyester amide copolymer comprising a copolymer of an aliphatic polyamide (A) and an aliphatic polyester (B), having a weight-average molecular weight of at least 40000 and containing at most 10 wt. % of a fraction having molecular weights of at most 10000, is produced through a production process including (1) a step at 100-150° C. of initial stage of distillation of low-molecular weight fraction including water and initial stage of (poly)esterification, (2) a step at 150-300° C. of polymerization and uniform melting and (3) a step under a reduced pressure of oligomer removal and polymerization. The resultant polyester amide copolymer is excellent in biodegradability and also excellent in physical properties represented by high strength and high heat resistance.

### TECHNICAL FIELD

The present invention relates to a polyester amide copolymer having biodegradability and excellent in high strength, high heat resistance, flexibility and molding processability, and process for production thereof. The polyester amide copolymer according to the present invention having a high strength and biodegratability, in the form of fiber, is suitable for fishing lines, fishing nets and nets for agricultural use. Further, the polyester amide copolymer according to the present invention having high strength, high heat resistance and biodegradability is also excellent in formability in films and is suitable as packaging materials for various materials such as food and as wrapping films.

### BACKGROUND ART

Recently, the disposal of waste plastics has become a serious problem. Accordingly, for consideration to the environment, the development and increased use of biodegradable plastics characterized by “non-accumulative characteristic” in the nature have become a great concern.

Representative biodegradable plastics developed up to the present are aliphatic polyester resins, such as polylactic acid resins, polybutyl succinate and polycaprolactone. Common defects of such biodegradable plastics are (1) low heat resistance, (2) low strength, (3) difficulty in control of biodegradability, etc., and the increase of usage and use thereof has not been necessarily achieved. Therefore, it has been tried to impart biodegradability by copolymerization to engineering plastics, such as polyethylene terephthalate, polybutylene terephthalate and polyamides, having excellent heat resistance and strength, mainly for improving the defects (1) and (2). Among them, aliphatic polyamides not only are excellent in strength but also have amide bonds which are abundantly present in living bodies, and are expected to be copolymerized with aliphatic polyesters which are a representative of biodegradable plastics known heretofore, thereby providing polyester amide copolymers as a biodegradable plastic having improved the above-mentioned defects (1)-(3). Polymerization processes for production of polyester amide copolymers known heretofore may be roughly classified into three types as follows.

Monomer (M/M) Process (Polymerization Process-1):

All the starting materials are monomers, and are synthesized into a polyester amide copolymer by a polymerization reaction (e.g., JP-A 7-102061). This process has been known from years ago but involves problems that special expensive cyclic compounds are exclusively required as monomers for developing a sufficient biodegradability, and sufficient heat resistance and high strength cannot be developed sometimes.

Polymer (P/P) Process (Polymerization Process-2):

The starting materials for the amide component and the ester component are both high-molecular weight polymers or low-molecular weight oligomers (e.g., JP-A 7-157557). This process involves problems such that the produced polyester amide copolymer becomes expensive, the resultant copolymer is caused to have a low molecular weight and a third component is required to increase the molecular weight, thus resulting in a further complicated operation and a further expensive polymer.

Polymer/Monomer (P/M) Process (Polymerization Process-3):

A starting material for one of aliphatic polyamide component and aliphatic polyester component is a monomer, and a starting material for the other component is a high-molecular weight polymer or a low-molecular weight oligomer. A process using a polyamide and a lactone compound is known (JP-A 4-36320) for example, but this process is not economical because a special monomer is used. Moreover, as depolymerization of the polymer is also promoted at the time of trans-esterification by reaction with the monomer, the resultant polyester amide copolymer cannot have a sufficiently increased molecular weight and is thus yet unsatisfactory also in respect of strength. For example, the resultant polyester amide copolymer was reported to provide shaped films having tensile strengths of 320-400 kg/cm² (ca. 30-40 MPa) Further, a polyester (polylactone) presumably by-produced together with the copolymer was separated as a chloroform-soluble matter from the product polyester amide copolymer, so that the product yield is also unsatisfactory.

### DISCLOSURE OF INVENTION

In view of the above-mentioned prior art, the present invention aims at providing a polyester amide copolymer which is inexpensive, has excellent properties for practical use, such as heat resistance and mechanical strength, and also has biodegradability; and also a process for production thereof.

According to our study, it has been found that molecular weight characteristics, particularly a high weight-average molecular weight and a reduction of low-molecular weight fraction (molecular weight: 1000 or below), are extremely important for development of physical properties, such as heat resistance and mechanical strength, of the product polyester amide copolymer regardless of which polymerization process is adopted, and that for the production of such a polyester amide copolymer, it is very effective to rely on the above-mentioned Polymer/monomer (P/M) process (Polymerization process-3) while selecting appropriate polymer and monomer and proceeding with the polymerization under strictly controlled conditions.

The polyester amide copolymer of the present invention is based on the above findings, and more specifically comprises a copolymer of an aliphatic polyamide (A) and an aliphatic polyester (B), has a weight-average molecular weight of at least 40000 and contains at most 10 wt. % of a fraction having molecular weights of at most 1000.

Further, the process for producing a polyester amide copolymer according to the present invention, comprises: a process for producing a polyester amide copolymer, comprising subjecting a mixture of an aliphatic polyamide (C) and a monomer of aliphatic polyester (B) successively to: (1) a first step of reaction at 100-150° C. in the presence of a catalyst while distilling off a low-molecular weight fraction containing water or an alcohol to render the mixture in a substantially uniform state, (2) a second step of polymerization of the mixture in a uniform molten state at 150-300° C., and (3) a third step of oligomer removal and higher polymerization at 150-300° C. under a reduced pressure. A particularly important aspect of the process for producing a polyester amide copolymer according to the present invention is to provide a product polyester amide copolymer with a higher polymerization degree while preventing depolymerization thereof and allowing effective removal of oligomer remarkably affecting adversely to the properties, such as strength through a process combination of step (1) of reaction at a relatively low temperature of 100-150° C. while distilling off a low-molecular weight fraction containing water or an alcohol to render the mixture in a substantially uniform state, step (2) of proceeding with polymerization until a uniformly molten state and then step (3) of removing oligomers (a fraction having molecular weights of at most 10000) and further proceeding with the polymerization. It is also effective to subject the once-produced polyester amide copolymer to heating for oligomer removal and further polymerization in a molten state in a temperature region of from its melting point to the melting point +150° C., from the viewpoint of further oligomer removal and provision of a higher molecular weight to the resultant polyester amide copolymer.

According to our study, it has been also found that in order to obtain a polyester amide copolymer having a satisfactory harmonization of biodegradability and physical properties as represented by mechanical strength and heat resistance, it is desirable for the polyester amide copolymer to assume a form of block co polymer having respective blocks with controlled average molecular chain lengths and have an entire molecular weight (specified by a solution viscosity (inherent viscosity)) maintained at a high level, and that for the purpose of producing such a polyester amide copolymer, it is very effective to use a process (so-called P/P/M process) wherein three species (P/P/M) of an aliphatic polyamide (P), an aliphatic polyester (P) which is a ring-opening polymer of a cyclic ester and a cyclic ester or cyclic amide (M) are used as starting materials, and a mixture of these is subjected to ester-amide exchange and polycondensation reactions.

Based on the above finding, the polyester amide copolymer of the present invention is also characterized by comprising a copolymer of an aliphatic polyamide and an aliphatic polyester that is a ring-opening polymer of a cyclic ester, and by a solution viscosity (inherent viscosity) of at least 0.7 dl/g.

Further, a second process for producing a polyester amide copolymer according to the present invention comprises holding a mixture of an aliphatic polyamide (C), an aliphatic polyester (B) that is a ring opening polymer of a cyclic ester, and a cyclic ester (F) or cyclic amide (G), in a hot molten state at a temperature between the melting point of the polyamide and ca. 300° C. until the mixture assumes a transparent state to proceed with an ester-amide exchange reaction, and then proceeding with polycondensation at a lower temperature.

### BEST MODE FOR PRACTICING THE INVENTION

Hereinbelow, the polyester amide copolymer according to the present invention is described successively along steps in the production process thereof.

1. Starting materials

(Aliphatic Polyamide (C))

A first starting material used in the process for producing the polyester amide copolymer according to the present invention is an aliphatic polyamide (C). The aliphatic polyamide (C) comprises a monomer substantially identical to that of an aliphatic polyamide (A) constituting the product polyester amide copolymer but has a larger molecular weight than a block unit of the aliphatic polyamide (A) in the product polyester amide copolymer.

More specifically, as the aliphatic polyamide (C), polycondensates of aliphatic dicarboxylic acids and aliphatic diamines, or ring-opening polymers of lactams, may be used. More specifically, it is possible to use polyamide 6 (nylon 6), polyamide 6,6, (nylon 6,6), polyamide 12 (nylon 12), polyamide 6,10 (nylon 6,10), or a copolymer of these or a blend of two or more species. Among them, polyamide 6, polyamide 6,6, or a copolymer of these, is preferred, and polyamide 6 (nylon 6) is particularly preferred, for the purpose of obtaining a harmonization of strength and biodegradability of the product polyester amide copolymer. The aliphatic polyamide (C) as a starting material may preferably have a number-average molecular weight in a range of 500-100,000, further preferably 10,000-50,000, particularly preferably 10,000-25,000. If the number-average molecular weight is below 500, it becomes difficult to obtain a high molecular weight of the resultant polyester amide, and in excess of 100,000, a long period is required for the polymerization and particularly high temperatures are required in the first step and the second step so that it becomes difficult to obtain a polyester amide having a high molecular weight and a high melting point as the final product.

(Monomers of Aliphatic Polyester (B))

A second starting material used in the process for producing the polyester amide copolymer according to the present invention is a monomer constituting the aliphatic polyester (B) contained in the product polyester amide copolymer and may preferably comprise at least two species selected from the group consisting of: aliphatic dicarboxylic acids or aliphatic dicarboxylic acid esters (D), aliphatic diols (E) and alicyclic esters (F).

Specific examples of the aliphatic dicarboxylic acid (D) may include: adipic acid, succinic acid, oxalic acid and esters of these, and adipic acid is particularly preferably used because it easily provides a polyester amide having high strength and biodegradability in combination and is commercially available inexpensively.

Specific examples of the aliphatic diols (E) may include: ethylene glycol, 1,4-butanediol, 1,3-propanediol, 1,6-hexanediol and diethylene glycol, and 1,4-butanediol is particularly preferably used because it easily provides a polyester amide having high strength and biodegradability in combination and is commercially available inexpensively.

As the alicyclic esters (F), lactones, such as δ-valerolactone, ε-caprolactone, γ-caprolactone and δ-caprolactone may be used.

In the case of using an alicyclic ester (F), it is possible to produce a polyester amide copolymer without using another monomer of an aliphatic dicarboxylic acid or aliphatic dicarboxylic acid ester (D) or an aliphatic diol (E), but when an alicyclic ester (F) alone is used as a monomer, because of a high reaction rate of the alicyclic ester (F), an aliphatic polyester as the homopolymer thereof is formed ordinarily, and the objective polyester amide-forming reaction is caused to proceed as an inter-polymer ester-amide exchange reaction between the polyester and the polyamide, so that it becomes difficult obtain a high-molecular weight product. Accordingly, even in the case of using an alicyclic ester (F), it is preferred to co-use another monomer. More preferably, it is preferred to use an aliphatic dicarboxylic acid or aliphatic dicarboxylic acid ester (D) and an aliphatic diol (E), or a system of co-using these together with an alicyclic ester (F) in a proportion of at most 50 mol % in terms of ester of the total monomers.

As for the quantity ratio between the aliphatic dicarboxylic acid or aliphatic dicarboxylic acid ester (D) and the aliphatic diol (E), the aliphatic diol (E) may be used in excess of 1 mol with respect to 1 mol of the aliphatic dicarboxylic acid or aliphatic dicarboxylic acid ester (D). It is particularly preferred to use an excessive mol of the aliphatic diol (E) with respect to the aliphatic dicarboxylic acid or aliphatic dicarboxylic acid ester (D), so as to provide a uniform state of the reaction product in the steps (1) and (2), and a mol ratio of 1.1:1-10:1 is further preferred. Below 1.1 mol, it is difficult to obtain a high-molecular weight polyester amide, and in excess of 10, a long period of time is required for distilling off the excessively used aliphatic diol (E) or the polyester amide is liable to have a lower melting point. It is further preferred to use the monomers of aliphatic polyester (B) and the aliphatic polyamide (C) in such amounts as to provide an ester/amide mol ratio in a range of 5/95-50/50 in the starting material mixture. If the ester/amide ratio is below 5/95, it becomes difficult to develop the biodegradability, and above 50/50, it becomes difficult to develop the mechanical strength.

2. Catalyst

Step (1) of the process for producing the polyester amide copolymer according to the present invention is a step of esterification of the ester monomers in the presence of a catalyst and distilling off a low-molecular weight fraction containing water or alcohol generated along with the esterification. The catalyst is used for promoting the esterification in this step (1) and subsequent ester-amide exchange reaction, and it is possible to use a catalyst ordinarily used for production of polyesters by polycondensation or ring-opening polymerization, or a catalyst used for trans-esterification or ester-amide exchange reaction. The catalyst is not particularly restricted, and examples thereof may include: metals, such as lithium, sodium, potassium, cesium, magnesium, calcium, barium, strontium, zinc, aluminum, titanium, cobalt, germanium, tungsten, tin, lead, antimony, arsenic, cerium, boron, cadmium, manganese and zirconium; organometallic compounds containing these metals; organic salts of these metals; metal alkoxides of these metals; and metal oxides of these metals. The catalysts can be in the form of a hydrate. Further, these catalysts may be used singly or co-used in two or more species.

Particularly preferred catalysts may include: tetrabutyltitanium, calcium oxide, zinc oxide, zinc stearate, zinc benzoate, stannous chloride, stannic chloride, diacyltin (I), tetraacyltin (II), dibutyltin oxide, dibutyltin dilaurate, dimethyltin maleate, tin dioctanoate, tin tetraacetate, triisobutylaluminum, tetrabutyl titanate, tetrapropoxy titanate, germanium dioxide, tungstic acid, and antimony trioxide. These catalysts can be in a hydrate form, and can be used singly or co-used in two or more species. In order to effectively proceed with the reaction of the present invention and obtain a high-molecular weight polyester amide, it is particularly preferred to use tetrabutyltitanium, calcium oxide, zinc oxide, zinc stearate, zinc benzoate, germanium dioxide, tungstic acid, antimony trioxide, etc., and they can be in a hydrate form.

These catalysts may preferably be used in a proportion in a range of 0.0001-1 mol, particularly 0.001-0.5 mol per 1 mol of ester monomer, i.e., the aliphatic dicarboxylic acid or aliphatic dicarboxylic acid ester (D) or the cyclic ester monomer, that is a total amount of acid-supplying monomer. In the case of using two or more species of catalysts, the total mol % thereof should preferably be in the above range.

3. Production Process

In the low-molecular weight faction distillation initiation step (1), i.e., the first step of the polyester amide production process according to the present invention, it is preferred to cause at least ca. 5%, more preferably ca. 10% or more of the reaction of the monomers of the aliphatic polyester (B), that is to initiate the (poly)esterification, at a relatively low temperature of 100-150° C., and render the mixture in a substantially uniform state. For this purpose, the system is held in the temperature region of 100-150° C. for 0.5-12 hours, particularly 1-6 hours. The substantially uniform state means a state wherein the aliphatic polyamide (C) is at least partially dissolved or melted or substantially uniformly swollen to provide a transparent state which can be confirmed by observation with human eyes. In this step, it is preferred to start the initial stage of (poly) esterification and suppress the competition with polymerization accompanied with ester-amide exchange reaction expected to be caused in the next step (2), so as to provide the finally produced polyester amide copolymer with a high molecular weight and a reduced oligomer content. Below 100° C., the (poly)esterification proceeds slowly and it becomes difficult for the reaction mixture to assume a substantially uniform state. In excess of 150° C., the low-molecular weight compound of water or alcohol formed in the esterification is liable to cause abrupt evaporation, or the ester monomer (particularly the aliphatic diol (E)) is liable to be partially distilled off to change the composition of the reaction mixture, and the ester-amide exchange reaction is liable to occur abruptly, so that the provision of high molecular weight and high melting point to the final product of polyester amide copolymer is liable to become difficult. Below 0.5 hour, the reaction cannot proceed sufficiently, and above 12 hours, the provision of high molecular weight and high melting point to the product polyester amide copolymer is liable to become difficult. The degree of (poly)esterification in this step can be determined from analysis of the amount of low-molecular weight fraction, such as water or alcohol resulting from the reaction of the aliphatic dicarboxylic acid or aliphatic dicarboxylic acid ester (D) with the aliphatic diol (E), the amount of low-molecular weight fraction, such as water or alcohol resulting from the excessively used aliphatic diol (E), the recovered amount of the excessively used aliphatic diol (E) and the residual amount of the cyclic ester monomer (F). As far as the above conditions are satisfied, however, a constant temperature is not necessarily required, and a gradual temperature increase from 100° C. to cause a continuous transition to the subsequent polymerization step (2) accompanied with polyesterification and ester-amide exchange reaction is rather preferred to promote the (poly) esterification and removal of the low-molecular weight fraction including water or alcohol in the last period of step (1).

The step (2) of the process for producing the polyester amide copolymer according to the present invention is substantially a first polymerization step wherein the mixture principally comprising the aliphatic polyamide (C), a polyesterified product of the monomers of the aliphatic polyester (B) and the residual monomers resultant after the above step (1) (wherein at least approximately 10 or more % of esterification has proceeded and a low-molecular weight fraction including the corresponding amount of water or alcohol has been removed), is held in a molten state to uniformize the polymers while causing the ester-amide exchange reaction, and it is preferred that the mixture is rendered into a transparent molten mixture liquid at least in this stage. In this step (2), the mixture is held in a temperature region of 150-300° C., preferably 150-280° C. for a period of 1-20 hours, more preferably 2-10 hours. It is preferred to distil off at least 15% of the theoretical amount of the low-molecular weight fraction including water produced by complete esterification. In this instance, the theoretical amount includes the amount of water or alcohol produced by the reaction of the total aliphatic dicarboxylic acid or total aliphatic dicarboxylic acid ester (D). Further, in the case of using the cyclic ester monomer (F), the total amount thereof is assumed to be reacted, and if the aliphatic dicarboxylic acid or aliphatic dicarboxylic acid ester (D) and the aliphatic diol (E) are do-used in the reaction, the total amount of water or alcohol produced from the total aliphatic dicarboxylic acid or total aliphatic dicarboxylic acid ester (D) and the equi-molar amount of the aliphatic diol (E) plus the excessive amount of the aliphatic diol (E) is taken as the theoretical amount.

In the subsequent step (3), the distillation of the low-molecular weight fraction including water and remaining in the system is completed, and further the resultant polyester amide copolymer is caused to have a further increased molecular weight while reducing the oligomers (a fraction having molecular weights of 10000 or below), under a reduced pressure. It is preferred that the pressure of the system is reduced to at most 300 Pa, and the temperature is held in a range of 100-300° C. particularly 150-280° C., for 1-100 hours, particularly 2-80 hours. In the step (3), it is particularly effective for reduction of the oligomers in the product polyester amide copolymer that the reduction of the pressure down to 100 Pa or below is accomplished as quickly as possible, more preferably within at most 140 min., preferably at most 120 min., further preferably at most 60 min.

In case where the desired increase of molecular weight and reduction of oligomers (for which purpose, it has been confirmed effective to use a combination of the aliphatic dicarboxylic acid or aliphatic dicarboxylic acid ester (D) and the aliphatic diol (E) as the monomers of the aliphatic polyester (B)) are not sufficiently attained in the step (3), it is preferred to subject a solid polymer once obtained through the step (3) again to a further oligomer removal and polymerization step under a reduced pressure in a temperature region of from its melting point to the melting point +150° C., for further increase of the molecular weight and reduction of the oligomers. In this step, it is preferred that the reduced pressure is at most 300 Pa, particularly at most 100 Pa, and the temperature is held in the range of the melting point to the melting point +150° C., particularly the melting point to the melting point +100° C., for 0.5-200 hours, particularly 1-15 hours.

4. Polyester Amide Copolymer

The polyester amide copolymer according to the present invention obtained through the above-mentioned production process of the present invention is characterized as a copolymer comprising an aliphatic polyamide (A) and an aliphatic polyester (B), having a weight-average molecular weight of at least 40000, and containing at most 10 wt. % of a fraction (oligomers) having molecular weights of at most 10000. It is preferred that the weight-average molecular weight is at least 50000, and the oligomer content is at most 8 wt. %, further at most 5 wt. %, particularly at most 2 wt. %. As is understood from the foregoing description, if the weight-average molecular weight is below 40000 or the oligomer content exceeds 10 wt. %, the physical properties including mechanical strength and heat-resistance are remarkably lowered.

Further, the improved molecular weight distribution of the polyester amide copolymer according to the present invention is represented by a low disperse factor (Mw/Mn) defined as a ratio of weight-average molecular weight (Mw) to a number-average molecular weight (Mn) of, preferably below 2.5.

The heat resistance of the polyester amide copolymer of the present invention is represented by, e.g., a crystal melting point of at least 100° C. preferably at least 130° C. The other excellent and preferred properties of the polyester amide copolymer of the present invention may include: a Tc2 (a crystallization temperature on temperature decrease in the DSC measurement) of at least 60° C., and an inherent viscosity (measured at 30° C. in hexafluoro-isopropanol solvent by means of a Ubbelohde viscometer) of at least 0.9 dl/g, particularly 1.0 dl/g.

5. Second Production Process

A description of the second process for producing a polyester amide copolymer according to the present invention is supplemented.

(Aliphatic Polyamide)

The first starting material used in this process is an aliphatic polyamide, similar to the one used in the first production process.

(Aliphatic Polyester (Ring-Opening Polymer of Cyclic Ester))

The second starting material used in the second production process an aliphatic polyester that is a ring-opening polymer of a cyclic ester. Specific examples of the cyclic ester may include: lactones, such as β-lactone, γ-lactone, δ-lactone and ε-lactone; glycolide (cyclic dimmer of glycolic acid), and lactide (cyclic dimmer of lactic acid). Poly-ε-lactone, that is a ring-opening polymer of ε-lactone, is particularly preferably used. The aliphatic polyester as the starting material may preferably have a number-average molecular weight of 500-500,000, particularly 4,000-100,000. If the number-average molecular weight is below 500, it is difficult to obtain a high polymerization degree at the time of condensation reaction. On the other hand, above 500,000, the stirring is liable to be difficult.

(Cyclic Ester or Cyclic Amide)

The third starting material used in the second production process is a cyclic ester or a cyclic amide.

Specific examples of the cyclic ester may include: lactones and glycolides corresponding to the above-mentioned aliphatic polyester; and specific examples of the cyclic amide may include: lactams which are also preferred examples of the monomers corresponding to the above-mentioned aliphatic polyamide.

The cyclic ester or cyclic amide remarkably promotes the ester-amide exchange reaction under heating between the aliphatic polyamide and the aliphatic polyester to allow the ester-amide exchange reaction at a lower temperature, thereby functioning to prevent a lowering in molecular weight of the resultant polyester amide copolymer. The function of the cyclic ester or cyclic amide may be attributable to a structural similarity thereof to the monomer of the aliphatic polyester or aliphatic polyamide, and also from this viewpoint, the most preferred cyclic ester is ε-caprolactone and the most preferred cyclic amide is ε-caprolactam.

More specifically, there has been known a process of subjecting polycaprolactone and polyamide to ester-amide exchange reaction, at a high temperature (JP-B 57-26688) or under heating in the presence of water (JP-A 7-157557), to produce a polyester amide copolymer. However, in such a system of reaction between polymers, the copolymerization reaction does not proceed completely, so that the product fails to exhibit a single crystallization temperature on temperature increase in DSC measurement in amorphous state. Further, as the reaction is caused at a temperature substantially higher than the melting points of the polyamide and polyester components, the polyamide and polyester components are liable to cause thermal decomposition, thus failing to provide a sufficient mechanical strength.

In contrast thereto, when a cyclic ester or cyclic amide is caused to be co-present in addition to the above-mentioned aliphatic polyamide and aliphatic polyester according to the present invention, a transparent uniform liquid state representing an apparent completion of the ester-amide exchange reaction (resulting in the product polyester amide copolymer showing a single crystallization temperature on temperature increase from the amorphous state) is attained in a relatively short time. As a result, by proceeding with polycondensation thereafter at a lower temperature, it has been found possible to provide a polyester amide copolymer with a degree of ester-amide exchange reaction sufficient to provide biodegradability while retaining a high molecular weight (solution viscosity), as a whole, sufficient to provide mechanical strength.

According to our knowledge, it is remarkably preferred for enhancing the physical properties inclusive of heat resistance and mechanical strength of the product polyester amide copolymer that the polyester amide copolymer has a solution viscosity (inherent viscosity) of at least 0.7 dl/g, more preferably at least 0.8 dl/g, further preferably at least 0.9 dl/g.

The amounts of the starting materials may be determined so as to realize the above-mentioned preferred molecular weight and average molecular chain length of the product polyester amide copolymer.

More specifically, it is preferred that the product polyester amide copolymer has a polyamide content of 50-95 mol %, particularly 60-90 mol %, and a polyester content of 5-50 mol %, particularly 10-40 mol %. Further, the amounts of the three starting materials (i.e., the aliphatic polyamide, the aliphatic polyester and the cyclic ester or cyclic amide) are so determined as to satisfy the above-mentioned polyamide content and polyester content in the product polyester amide copolymer within the composition range among the three starting materials such that the aliphatic polyamide is 25-85 mol %, particularly 30-81 mol %; the aliphatic polyester is 4.5-25 mol %, particularly 9-20 mol %; and the cyclic ester is 0.5-25 mol %, particularly 1-20 mol %, or the cyclic amide is 9-30 mol %, particularly 9.5-25 mol %.

According to the second production process for polyester amide copolymer of the present invention, the above-mentioned aliphatic polyamide, aliphatic polyester and cyclic ester or cyclic amide, are subjected to ester-amide exchange reaction at a temperature between ca. 190° C. (melting point of polyamide) and ca. 300° C., more preferably in a temperature range of 210-280° C. In this instance, a conventional trans-esterification catalyst, such as (anhydrous) zinc acetate, zinc stearate or tetra-n-butyl titanate is caused to be co-present in an amount of 0.1-10 wt. parts, particularly 0.2-1.0 wt. part per 100 wt. parts in total of the above-mentioned starting materials. By holding the starting material mixture at the above-mentioned temperature for 1-15 hours, particularly 2-10 hours, the mixture arrives at a uniform transparent liquid state representing an apparent completion of the ester-amide exchange (leading to a single crystallization temperature on temperature increase of the product polyester amide copolymer)

When the system has reached a transparent uniform liquid state, the system temperature is lowered as quickly as possible down to a temperature of 150-260° C., particularly 170-230° C. (which is preferably also a temperature lower by at least 10° C. particularly by 20-100° C., than the ester-amide exchange reaction temperature) to proceed with polycondensation. If the system is held at the ester-amide exchange temperature even after reaching the transparent uniform liquid state, the depolymerization of the polyamide block proceeds, thus failing to satisfy the condition of average chain length required from the physical properties of the product polyester amide copolymer.

The polycondensation is continued until the stirring torque increases to become a substantially constant level.

The polyester amide copolymer obtained through the second process assumes a form of block copolymer of aliphatic polyamide and aliphatic polyester, as mentioned above, and is caused to have an inherent viscosity (corresponding to a number-average molecular weight) of at least 0.7 dl/g, preferably at least 0.8 dl/g, further preferably at least 0.9 dl/g. Further, the copolymer shows a single crystallization temperature in a temperature range of 10-150° C. and a melting point in a range of 150-210° C., in the course of temperature increase.

The polyester amide copolymer according to the present invention is a biodegradable plastic having improved physical properties, and is used for forming into, e.g., fiber products, such as fishing lines, fishing nets and agricultural nets, and various film products useful as food packaging materials, etc., through extrusion and stretching.

### EXAMPLES

Hereinbelow, the present invention will be described more specifically based on Examples and Comparative Examples. The polyester amide copolymers obtained in the respective examples were subjected to measurement of the following properties.

(DSC Measurement)

“DSC-30” (made by Mettler Instrument AG) was used for the measurement. Temperature calibration of the apparatus was effected based on the melting points of indium, lead and zinc. The measurement was performed by placing ca. 10 mg of a sample in an aluminum pan and under a dry nitrogen stream (10 ml/min) and at temperature-raising and temperature-lowering rates of 10° C./min., respectively.

(Molecular Weight and Molecular Weight Distribution)

A GPC-system apparatus of Shimadzu Seisakusho K.K. was used. The main components were a pump (“LC-9A”), a detector (“RID-6A”), and an analyzer (“CR-4A”). Two columns of Shodex “HFIP-LG” and “HF-IP” (made by Showa Denko K.K. were used in an oven at 40° C. The elution liquid was formed by dissolving sodium trifluoride (made by Kanto Kagaku K.K.) at a concentration of 5 mM in hexafluoroisopropanol (made by Central Glass K. K.) after distillation and flowed at a rate of 1 ml/min. The molecular weight determination was performed based on a calibration curve prepared by using 5 species of standard polymethyl methacrylate having different molecular weights (made by Polymer Laboratories, Inc.) The measurement was performed by injecting 100 μl of a sample solution formed by adding the above-mentioned elution liquid to 10 mg of a sample up to a total of 10 ml, followed by complete dissolution of the sample.

The calculation of molecular weight and molecular weight distribution was performed based on a base line drawn on a resultant GPC curve so as to connect a point of initiation of a curve based on a maximum molecular weight fraction and a point of minimum molecular weight 1000.

(Oligomer Fraction Content)

From a molecular weight distribution curve prepared in the above GPC measurement, a proportion of component having molecular weights of at most 10000 was calculated and taken as an oligomer (fraction) content.

(Solution Viscosity)

A sample solution was prepared by dissolving a polymer in solvent hexafluoroisopropanol (made by Central Glass K. K.) as it was, so as to provide a polymer concentration of 1 wt. %. The sample solution was prepared in a Ubbelohde-type solution viscometer, and the viscometer was set in a water bath accurately regulated at 30° C., and after standing for 10 min., the viscosity was measured. Incidentally, the viscometer was one giving a dropping time of 100 sec. for the solvent alone under the identical condition.

(Melt Viscosity)

Before the measurement, a polymer was treated at 100° C. for 12 hours under vacuum in a vacuum drier. Then, ca. 20 g of the polymer was placed in a barrel of a capillary-type melt viscometer (“CAPILLOGRAPH”, made by Toyo Seiki K.K.) equipped with a (flat-type) capillary of a nozzle diameter=1 mm and L/D=10 heated to 160-180° C., and after 5 min. of preheating, the melt viscosity was measured at various plunger descending speeds. A value measured at a shear rate of 122 sec⁻¹ was taken as a melt viscosity.

(Physical Properties of Yarn)

<Preparation of Yarn>

Each polymer synthesized in the respective Examples and Comparative Examples described hereinafter was processed into a yarn (filament) in the following manner.

Each polymer, before spinning, was treated at 100° C. for 12 hours under vacuum in a vacuum drier. For the spinning, ca. 20 g of each polymer was placed in a barrel of a capillary-type meltviscometer (“CAPILLOGRAPH”, made by Toyo Seiki K.K.) equipped with a (flat-type) capillary of nozzle diameter=1 mm and L/D=10, and after being preheated for 5 min., was extruded into a yarn at a plunger descending speed of 5 mm/min. The temperatures of the barrel and capillary for the yarn extrusion were set in a range of 160-180° C. while observing the state of the yarn. The extruded yarn out of the nozzle was cooled in air and taken up at a speed identical to the ejection speed out of the nozzle.

The extruded yarn was stretched under heating. More specifically, a yarn in a sample length of 50 mm was set on a stretching apparatus placed in a thermostat vessel at 80° C. and stretched at 6 times in length. The stretched yarn was set in the temperature state for 1 min.

<Measurement>

Each sample yarn prepared in the above manner was subjected to measurement of tensile strength and elongation by using “TENSILON UTM-30” (made by Toyo Baldwin K.K.) placed in a room adjusted at 25° C. and 50% RH. A yarn of 100 mm was set on the apparatus and measured at a crosshead speed of 100 mm/min. The measurement was performed 5 times by using 5 yarns, and an average value thereof was taken.

The polyester amide copolymers prepared according to the second production process were further subjected to measurement of the following properties.

(1) Primary structure (Structural Analysis by ¹³C-NMR)

Ester/Amide Ratio

The ratio was determined based on the magnitude of respective carbonyl carbon peaks in polyester and polyamide.

Bond Proportion

Methylene carbon peaks adjacent to the carbonyl carbons involved in the ester bond and the amide bond, were noted. When amide-ester and ester-amide bonds are formed in the ester-amide exchange reaction, the peaks of methylene carbons bonded to the carbonyl carbons involved in the bonds are shifted. The proportions of the respective bonds of amide-amide, amide-ester, ester-ester and ester-amide can be determined from the ratio between the original peaks and the shifted peaks and the ester/amide ratio.

Average Block Length

A product polylactone amide is assumed to have been polymerized in a single polymer chain, and is arranged so as to fit to the above-obtained bond proportions, thereby obtaining the respective average block lengths.

(2) Biodegradability (under Composting Condition)

The measurement was performed by using a microorganism oxidative decomposition apparatus (“MODA”, made by Hishisan Products K.K.). More specifically, 10 g of a finely pulverized sample was blended with microorganism source and sea sand and filled in a reaction tube. Then, into the reaction tube held at 50° C., air from which carbon dioxide gas was removed was supplied at a rate of 20 ml/min. for 45 days. From the reaction tube, carbon dioxide, ammonia and water were generated as reaction products of microbiological decomposition, from which carbon dioxide alone was selectively recovered. The amount of the recovered carbon dioxide was divided by the amount of carbon dioxide expected to be generated from the total carbon in the sample. If the ratio was 3% or more, the sample was judged to have biodegradability, and below 3%, no biodegradability.

(3) Linear Strength

(i) Sample Preparation

A monofilament of ca. 0.2 mm in diameter was formed by using a 35 mm-dia. extruder under the following conditions.

Extrusion temperature: 195° C. and 230° C.

Cooling bath temperature: 5° C.

1st. step stretching: 4.30 times at 23° C.

2nd step stretching: 1.57 times at 140° C.

Total stretching ratio: 6.75 times

Heat treatment or relaxation: none.

(ii) Strength Measurement

A tensile strength of the thus-obtained mono-filament was measured by using “TENSILON RTM-100” (made by Orientec K.K.).

Test temperature: 23° C.

Sample length: 300 mm

Tensile speed: 300 mm/min.

### Example 1

According to Polymerization process-3 (P/M process), a polyester amide having an ester/amide mol ratio of 30/70 was prepared by using an aliphatic polyester monomer mixture at a 1,4-butanediol/adipic acid mol ratio of 3 through the following steps.

First step: Into a glass-made reactor equipped with a stirrer, a nitrogen-intake pipe and a reaction product effluent pipe, 65.76 g (0.45 mol) of adipic and 121.66 g (1.35 mol) of 1,4-butanediol and 181.82 g (1.05 mol) of nylon 6 were added together with catalysts of Sb₂ 03, calcium acetate monohydrate and manganese tetrahydrate (giving a total catalyst amount of 0.073 mol % with respect to the adipic acid). Under nitrogen flow and stirring, the system was heated by gradually raising the metal bath temperature from 100° C. to 150° C. in 40 min., followed by reaction at 150° C. for 1 hour, during which the reaction mixture assumed a viscous and substantially uniform state. In the reaction product effluent tube under cooling was accumulated 3 g of liquid which was found to be water in an amount of 19% of the theoretical amount water produced from the adipic acid and 1,4-butane diol (representing that ca. 19% of the esterification was caused).

Second step: Under a nitrogen gas flow at normal pressure, the system was heated by raising the metal bath temperature stepwise from 150° C. to 240° C. in 4.5 hours, followed by 1 hour of reaction at 240° C. for 1 hour, during which the reaction mixture exhibited a uniform transparent state, and a transparent liquid comprising water (as reaction product), 1,4-butanediol (excessively used starting material) and other substances was distilled out and recovered. The amount of the distilled-out product from the first step to the end of the second step was 28.2 g which corresponded to a recovery rate of 29% based on the theoretical amount of water and excessive amount of 1,4-butanediol.

Third step: The system was successively stirred at 240° C., and after stopping the nitrogen flow, was gradually placed under a reduced pressure by means of a vacuum pump. The pressure in the reaction vessel was lowered to 100 Pa or below in 30 min., during which an increase of the stirring torque was confirmed. After the prescribed time, the reaction system was restored to normal pressure, and a polymer was taken out. Throughout the whole steps, the total amount of the distilled-out and recovered components was 107.3 g corresponding to a recovery rate of 110% based on the amounts of theoretically produced water and excessive 1,4-butanediol. The polymer was colored in somewhat transparent pale green and recovered at a rate of 85%.

The physical properties measured according to the above-described methods of the polymer thus obtained are inclusively shown in Tables 1 and 2 appearing hereinafter together with the polymers obtained in other Examples and Comparative Examples described below.

### Example 2

According to Polymerization process-3 (P/M process), a polyester amide having an ester/amide mol ratio of 30/70 was prepared by using an aliphatic polyester monomer mixture at a 1,4-butanediol/adipic acid mol ratio of 2.

The first step and second step were repeated in a similar manner as in Example 1 except for using 74.53 g (0.51 mol) of adipic acid, 91.92 g (1.02 mol) of 1,4-butanediol and 134.66 g (1.19 mol) of nylon 6. The total catalyst amount was 0.065 mol % with respect to the adipic acid.

The appearance of the reaction mixture in the first step was in a substantially homogeneous state containing a slightly swollen transparent substance compared with the one in Example 1, and 5 g of distilled-out substance was recovered at the end of this step. The substance was composed mostly of water and in an amount of ca. 27% of the theoretical amount of water produced from the adipic acid and 1,4-butanediol (representing that ca. 27% of the esterification was caused).

The appearance of the reaction in the second step was substantially the same as in Example 1, resulting in a recovered amount of distilled-out product from the first step to the end of the second step of 26.48 g corresponding to a recovery rate of 41% based on the theoretical amount of water and excessive amount of 1,4-butanediol.

Further, the third step was repeated in a similar manner as in Example 1 except that the pressure in the vessel was reduced to 100 Pa in 45 min. The total amount of the components distilled out and recovered was 164.5 g corresponding to 111% based on the theoretical amount of water and excessive amount of 1,4-butanediol. The polymer exhibited a transparent pale green color and was recovered at a rate of 89%.

### Example 3

According to Polymerization process-3 (P/M process), a polyester amide having an ester/amide mol ratio of 30/70 was prepared by using an aliphatic polyester monomer mixture at a 1,4-butanediol/adipic acid mol ratio of 5.

The first step and second step were repeated in a similar manner as in Example 1 except for using 100.33 g (0.88 mol) of nylon 6. The total catalyst amount was 0.087 mol % with respect to the adipic acid.

The appearance of the reaction mixture in the first step was in a substantially homogeneous state at a lower viscosity compared with the one in Example 1, and 2.7 g of distilled-out substance was recovered at the end of this step. The substance was composed mostly of water and in an amount of ca. 20% of the theoretical amount of water produced from the adipic acid and 1,4-butanediol (representing that ca. 20% of the esterification was caused).

The appearance of the reaction in the second step was substantially the same as in Example 1, resulting in a recovered amount of distilled-out product from the first step to the end of the second step of 26.5 g corresponding to a recovery rate of 18% based on the theoretical amount of water and excessive amount of 1,4-butanediol.

Further, the third step was repeated in a similar manner as in Example 1 except that the pressure in the vessel was reduced to 100 Pa in 45 min. The total amount of the components distilled out and recovered was 164.5 g corresponding to 109% based on the theoretical amount of water and excessive amount of 1,4-butanediol. The polymer exhibited a transparent pale green color and was recovered at a rate of 89%.

### Example 4

According to Polymerization process-3 (P/M process), a polyester amide having an ester/amide mol ratio of 50/50 was prepared by using an aliphatic polyester monomer mixture at a 1,4-butanediol/adipic acid mol ratio of 1.2.

The first step and second step were repeated in a similar manner as in Example 1 except for using 137.51 g (0.94 mol) of adipic acid, 101.76 g (1.13 mol) of 1,4-butanediol and 106.48 g (0.94 mol) of nylon 6. The total catalyst amount was 0.035 mol % with respect to the adipic acid.

The appearance of the reaction mixture in the first step was in a substantially homogeneous state similarly as in Example 1, and 6 g of distilled-out substance was recovered at the end of this step. The substance was composed mostly of water and in an amount of ca. 18% of the theoretical amount of water produced from the adipic acid and 1,4-butanediol (representing that ca. 18% of the esterification was caused).

The appearance of the reaction in the second step was substantially the same as in Example 1, resulting in a recovered amount of distilled-out product from the first step to the end of the second step of 37.6 g corresponding to a recovery rate of 74% based on the theoretical amount of water and excessive amount of 1,4-butanediol.

Further, the third step was repeated in a similar manner as in Example 1 except the pressure in the vessel was reduced to 100 Pa in 15 min. The total amount of the components distilled out and recovered was 52.8 g corresponding to 104% based on the theoretical amount of water and excessive amount of 1,4-butanediol. The polymer exhibited a transparent pale green color and was recovered at a rate of 78%.

### Comparative Example 1

A polymer was prepared in the same manner as in Example 1 except that the pressure in the vessel was reduced to 100 Pa in 150 min.

The recovered amount of distilled-out product from the first step to the end of the second step of 23.8 g corresponding to a recovery rate of 25% based on the theoretical amount of water and excessive amount of 1,4-butanediol.

The total amount of the distilled-out and recovered components was 133.7 g corresponding to 137% based on the theoretical amount of water and excessive amount of 1,4-butanediol. The polymer exhibited a transparent pale green color and was recovered at a rate of 93%.

### Comparative Example 2

A polymer having an ester/amide mol ratio of 30/70 was prepared according to Polymerization process-1 (M/M process).

Into a glass-made reactor equipped with a stirrer, a nitrogen-intake pipe and a reaction product effluent pipe, 58.38 g (0.40 mol) of adipic acid, 72.0 g (0.80 mol) of 1,4-butanediol and 122.26 g (0.93 mol) of 6-amino-η-caproic acid were added together with catalysts of Sb₂O₃, calcium acetate monohydrate and manganese acetate tetrahydrate, and under nitrogen flow and stirring, the temperature was gradually raised from 100° C. Polymerization reaction under nitrogen flow was caused to proceed under heating by gradually raising the metal bath temperature from 100° C. to 220° C. in 4.5 hours, during which the attachment of water drops (that was a reaction product of adipic acid and 1,4-butanediol) onto the inner wall of the flask was observed. Thereafter, a transparent liquid composed of water as the reaction product, 1,4-butanediol as an excessively used starting material and other substances was distilled out and recovered.

Successively thereafter, the system was stirred at 220° C., and after stopping the nitrogen flow, was gradually rendered under a reduced pressure by means of a vacuum pump. Initially, a transparent liquid was distilled out vigorously as an effluence, and after the effluence became small in amount, the reduced pressure was enhanced until a pressure of 100 Pa in 60 min., followed by 12 hours of stirring in this state. During this period, an increase of the stirring torque was confirmed. After the prescribed time, the reaction system was reduced to normal pressure, and a polymer was taken out. Throughout the whole steps, the total amount of the distilled-out and recovered components was 92.3 g corresponding to a recovery rate of 109% based on the theoretical amount of water and excessive amount of 1,4-butanediol. The polymer was in a transparent pale green color and recovered at a rate of 90%.

### Comparative Example 3

A polymer having an ester/amide mol ratio of 50/50 was prepared according to Polymerization process-2 (P/P process).

Into a glass-made reactor equipped with a stirrer, a nitrogen-intake pipe and a reaction product effluent pipe, 10 g of polycaprolactone (“TOME P-787”, made by U.C.C.) and 10 g of nylon 6 (“AMILAN CM1041-LO”, made by Toray K.K.) were added together with 1 g of anhydrous zinc stearate (made by Kanto Kagaku K.K.) as catalyst. Under nitrogen flow (500 ml/min.), the mixture was melted and stirred on a metal bath at 300° C. for 150 min. of reaction. Thereafter, the molten reaction product was cooled by standing under a nitrogen gas flow to obtain a polymer.

### Example 5

The polymer synthesized in Comparative Example 1 was placed in a vacuum drier and treated therein for 4 days at an intra-apparatus temperature of 150° C. under 100 Pa. The polymer assumed a partially molten state and changed into a brownish color. The physical properties of the resultant polymer are shown in Table 2.

### Example 6

The polymer synthesized in Comparative Example 1 was placed in a glass-made reactor equipped with a stirrer, a nitrogen-intake pipe and a reaction product effluent pipe, and the system in the apparatus was held at 100 Pa or below by means a vacuum pump and was gradually raised in temperature. As the polymer started to melt, the polymer was stirred to allow reaction at 240° C. for 3 hours, during which the stirrer torque increased abruptly and a small amount of distilled-out liquid was confirmed. After the prescribed time, the product polymer was taken out and found to change into a pale brownish color. The physical properties of the resultant polymer are shown in Table 2.

TABLE 1

| | | Example | | | | | | |
|---|---|---|---|---|---|---|---|---|
| | | 1 | 2 | 3 | 4 | Comp. 1 | Comp. 2 | Comp. 3 |
| Polymerization process | | 3(P/M) | 3(P/M) | 3(P/M) | 3(P/M) | 3(P/M) | 1(M/M) | 2(P/P) |
| Ester/amide ratio | mol/mol | 30/70 | 30/70 | 30/70 | 50/50 | 30/70 | 30/70 | 50/50 |
| Diol/dicarboxylic acir ratio | mol/mol | 3.0 | 2.0 | 5.0 | 1.2 | 3.0 | 2.0 | |
| First step | | | | | | | | |
| Temp. | ° C. | 100˜150 | 100˜150 | 100˜150 | 100˜150 | 100˜150 | 100˜220 | 300 |
| Time | h | 1.7 | 1.7 | 1.7 | 1.7 | 1.7 | 4.5 | 2.5 |
| Degree of esterification | mol % | 19 | 27 | 20 | 18 | 19 | — | — |
| Second Step | | | | | | | | |
| Temp. | ° C. | 150˜240 | 150˜240 | 150˜240 | 150˜240 | 150˜240 | | |
| Time | h | 4.5 | 4.5 | 4.5 | 4.5 | 4.5 | | |
| Distilled recovery rate | % | 29 | 41 | 18 | 74 | 29 | — | |
| Third step | | | | | | | | |
| Temp. | ° C. | 240 | 240 | 240 | 240 | 240 | 220 | |
| Time to ≦100 Pa | min | 30 | 15 | 45 | 15 | 150 | 60 | |
| Reduced Pressure | Pa | ≦100 | ≦100 | ≦100 | ≦100 | ≦100 | ≦100 | |
| Time | h | 21 | 21 | 21 | 21 | 21 | 12 | |
| Total distilled recovery rate | % | 110 | 111 | 109 | 104 | 137 | 109 | |
| Polymer recovery rate | % | 85 | 89 | 89 | 78 | 93 | 90 | — |
| Polymer state | | pale green | pale green | pale green | pale green | pale green | pale yellow | pale yellow |
| Polymer properties | | | | | | | | |
| Tm | ° C. | 146 | 156 | 136 | 150 | 135 | 122 | 184 |
| Tc2 | ° C. | 91 | 102 | 97 | 98 | 82 | 80 | 150 |
| Inherent viscosity | dl/g | 1.20 | 1.17 | 1.00 | 1.20 | 0.88 | 0.76 | 0.67 |
| Molecular weight | | | | | | | | |
| Mn | | 58,000 | 51,000 | 55,000 | 53,700 | 25,600 | 19,600 | 13,000 |
| Mw | | 103,000 | 94,400 | 93,000 | 97,400 | 63,300 | 59,300 | 36,700 |
| Mw/Mn | | 1.8 | 1.9 | 1.7 | 1.8 | 2.5 | 3.0 | 2.8 |
| Oligomer content | % | 0.7 | 1.7 | 1.7 | 2.5 | 11.5 | 13.2 | 20.3 |
| Yarn properties | | | | | | | | |
| Spin. Temp | ° C. | 180 | 170 | 160 | 160 | 160 | 160 | spinning |
| | | | | | | | | impossible |
| Diameter | μm | 162 | 159 | 170 | 260 | 250 | 278 | |
| Max. stress | MPa | 481 | 359 | 320 | 225 | 175 | 162 | |
| Max. elongation | % | 77 | 98 | 113 | 151 | 77 | 80 | |

TABLE 2

| | | Example | | |
|---|---|---|---|---|
| | | Comp. 1 | 5 | 6 |
| Post treatment | | | | |
| Reduced pressure | Pa | | ≦100 | ≦100 |
| Temp. | ° C. | | 150 | 240 |
| Time | h | | 96 | 3 |
| Polymer properties | | | | |
| Tm | ° C. | 135 | 122 | 115 |
| Tc2 | ° C. | 82 | 76 | 95 |
| Inherent viscosity | dl/g | 0.92 | 1.17 | 2.31 |
| Molecular weight | | | | |
| Mn | | 25,600 | 26,500 | 29,300 |
| Mw | | 63,300 | 139,000 | 193,800 |
| Mw/Mn | | 2.5 | 5.3 | 6.6 |
| Oligomer content | % | 11.5 | 6.9 | 8.1 |
| Yarn properties | | | | |
| Spin. temp. | ° C. | 160 | 160 | 160 |
| Diameter | μm | 250 | 300 | 330 |
| Max. stress | MPa | 175 | 228 | 327 |
| Max. elongation | % | 77 | 84 | 46 |

Hereinbelow, Examples and Comparative Examples of the second process (i.e., P/P/M process) for producing a polyester amide according to the present invention are set forth.

### Example 11

In a reaction vessel, nylon 6, polycaprolactone and ε-caprolactone were placed in mol ratios of 70:21:9, and in a nitrogen atmosphere, were held at 220° C., followed by raising of the set temperature to 260° C. After the melting of nylon 6, the stirring speed was gradually raised, and after raising the system temperature up to 270° C., zinc acetate (catalyst) was added in an amount of 0.5 wt. part per 100 wt. parts of the whole charged materials to initiate an ester/amide exchange reaction.

After the reaction continued for ca. 6 hours at 270° C., the system changed from a white opaque state to a transparent state, when the ester/amide exchange was judged to be completed. Then, under continuation of the stirring, the temperature of the system was lowered to 220° C., followed by ca. 10 hours of continued polycondensation and then cooling to obtain a polyester amide copolymer according to the present invention.

The thus-obtained polyester amide copolymer exhibited: a melting point=180° C., a crystallization temperature on temperature increase=270° C. (single), an average molecular chain length in polyamide block=5.7, an average molecular chain length in polyester block=1.4, and an inherent viscosity (η inh)=1.0 dl/g. Further, the polymer exhibited a carbon dioxide gas generation rate of ca. 15% as a result of composting treatment under microbiological oxidation at 50° C. for 45 days and was judged to have biodegradability (: yes). Further, a monofilament of ca. 0.2 mm produced from the polymer exhibited a linear tensile strength of 670 MPa.

The outline of production and measured physical properties of the polyester amide copolymer are inclusively shown in Table 3 below together with the results of the following Examples and Comparative Examples.

### Example 12

A polyester amide copolymer was prepared and subjected to measurement of physical properties in the same manner as in Example 11 except that the ester/amide exchange reaction at 270° C. was continued for further 4 hours after reaching the transparent liquid state obtained after ca. 6 hours of the reaction.

As a result, there were observed lowerings in inherent viscosity and average molecular chain length in polyamide, and the linear tensile strength of monofilament was lowered to 320 MPa, which however was a substantially higher strength than a level obtained by a conventional process (e.g., 55 MPa obtained in Comparative Example 13 described later).

### Example 13

A polyester amide copolymer was prepared and subjected to measurement of physical properties in the same manner as in Example 11 except for using nylon 6, polycaprolactone and ε-caprolactone as the starting materials at mol ratios of 49:30:21 and performing the ester/amide exchange reaction at 300° C. for 1.3 hours.

### Comparative Example 11

A polyester amide copolymer was prepared and subjected to measurement of physical properties in the same manner as in Example 11 except for using nylon 6, polycaprolactone and ε-caprolactone as the starting materials at ratios of 50:35:15 and omitting the polycondensation.

### Comparative Example 12

A commercially available nylon 6 (“A1020BRL”, made by Unitika K.K.) was subjected to measurement of physical properties for comparative purpose. The polymer exhibited somewhat higher values with respect to melting point, inherent viscosity, liner strength, etc., than the polyester amide copolymers of Examples, but resulted in a carbon dioxide gas generation rate of 0%, thus exhibiting no biodegradability at all.

### Comparative Example 13

A polyester amide copolymer was prepared and subjected to measurement of physical properties in the same manner as in Example 11 except for using nylon 6 and ε-caprolactone as the starting materials at a mol ratio of 70:30 to effect 2 hours of ester/amide reaction at 280° C. and omitting the polycondensation at 200° C.

The thus-obtained polyester amide copolymer exhibited crystallization peak temperatures at 13° C. and 21° C., respectively, thus showing that the ester/amide exchange reaction was insufficient. The polymer also exhibited a substantially lower linear tensile strength of 55 MPa.

### Comparative Example 14

A polyester amide was prepared according to a P/P process as described in JP-A 7-157557. More specifically, nylon 6 and polycaprolactone were charged at a mol ratio of 70:30, and 4 wt. parts of water and 0.5 part of catalyst were added thereto. The system was heated up to 270° C. in a nitrogen atmosphere, followed by 4 hours of reaction under stirring. Thereafter, the atmosphere in the apparatus was rendered into a reduced pressure state to distill of water. After the torque increased sufficiently, the system was restored to normal pressure, and the molten reaction product was discharged and cooled to obtain a copolymer.

The results of the above Examples and

Comparative Examples are inclusively shown in Table 3 below.

TABLE 3
Production and evaluation of polyester amide copolymers

| | | Example | | | | | | |
|---|---|---|---|---|---|---|---|---|
| | | 11 | 12 | 13 | Comp. 11 | Comp. 12 | Comp. 13 | Comp. 14 |
| Polymerization proces | | P/P/M | P/P/M | P/P/M | P/P/M | | P/M | P/P |
| Amide/ester ratio (mol/mol) | | 70/30 | 70/30 | 70/30 | 50/50 | 100/— | 70/30 | 70/30 |
| Polymerization | Charge | | | | | | | |
| conditions | Nylon 6 | 70 | 70 | 49 | 50 | 100 | 70 | 70 |
| | Polycaprolactone | 21 | 21 | 30 | 35 | | 0 | 30 |
| | ε-caprolactone | 9 | 9 | 0 | 15 | | 30 | 0 |
| | ε-caprolactam | 0 | 0 | 21 | 0 | | 0 | 0 |
| | Exchange reaction | | | | | | | |
| | Reaction temp. (° C.) | 270 | 270 | 300 | 270 | | 280 | 270 |
| | Reaction time (hours) | 6 | 10 | 1.3 | 6 | | 2 | 4 |
| | Polycondensation @220° C. (hours) | 10 | 10 | 10 | none | | none | none |
| Thermal properties | Melting point (° C.) | 184 | 165 | 178 | 165 | 225 | 187 | 189 |
| | Crystal. temp, on temp. increase (° C.) | 27 | 24 | 27 | 22 | 64 | 13.21 | 12.20 |
| Primary structure | Average amide length | 5.7 | 3.4 | 5.1 | 3.3 | | 4.5 | 5.8 |
| | Average ester length | 1.4 | 1.4 | 1.2 | 3.1 | | 1.6 | 2.8 |

| | | | | | | | |
|---|---|---|---|---|---|---|---|
| Biodegradability (under composting condition) | yes | yes | yes | yes | none | yes | yes |
| Inherent viscosity (ηinh) | 1.0 | 0.7 | 0.9 | 0.5 | 1.8 | 0.5 | 0.5 |
| Linear strength (MPa) | 670 | 320 | 370 | 70 | 830 | 55 | 50 |

### INDUSTRIAL APPLICABILITY

As described above, the present invention provides a polyester amide copolymer which is excellent in biodegradability and also in physical properties represented by high strength and high heat resistance together with excellent formability, thus being suitably used for fiber products inclusive of fishing lines, fishing nets and agricultural nets, and for packaging materials for various contents inclusive of food, and a process for production thereof.

1. A polyester amide copolymer, comprising a copolymer of an aliphatic polyamide (A) and an aliphatic polyester (B), having a weight-average molecular weight of at least 40000, and containing at most 10 wt. % of a fraction having molecular weights of at most 10000.

2. A polyester amide copolymer according to claim 1, having a crystal melting point of at least 100° C.

3. A polyester amide copolymer according to claim 1, which has been obtained through molten copolymerization of an aliphatic polyamide (C) and a monomer of the aliphatic polyester (B).

4. A polyester amide copolymer according to claim 3, wherein the aliphatic polyamide (C) is polyamide 6.

5. A polyester amide copolymer according to claim 3, wherein the monomer of the aliphatic polyester (B) comprises at last two species selected from the group consisting of an aliphatic dicarboxylic acid or aliphatic dicarboxylic acid ester (D), an aliphatic diol (E) and an alicyclic ester (F).

6. A polyester amide copolymer according to claim 5, wherein the monomer of the aliphatic polyester (B) comprises a combination of the aliphatic dicarboxylic acid or aliphatic dicarboxylic acid ester (D) and the aliphatic diol (E).

7. A polyester amide copolymer according to claim 1, comprising a copolymer of an aliphatic polyamide and an aliphatic polyester which is a ring-opening polymer of a cyclic ester, and having an inherent viscosity of at least 0.7 dl/g.

8. A polyester amide copolymer according to claim 7, wherein the aliphatic polyamide comprises polyamide 6.

9. A polyester amide copolymer according to claim 7, wherein the cyclic ester is ε-caprolactone.

10. A polyester amide copolymer according to claim 7, having an average molecular chain length in polyamide block of 3-10, which is larger than an average molecular chain length in polyester block.

11. A polyester amide copolymer according to claim 10, wherein the average molecular chain length in (poly)ester block is 1-2.

12. A polyester amide copolymer according to claim 7, having a melting point of at least 160° C.

13. A polyester amide copolymer according to claim 12, showing a single crystallization temperature in a course of temperature increase from amorphous state.

14. A shaped product of a polyester amide copolymer according to claim 1.

15. A shaped product according to claim 14, in any one form of monofilament fiber, multifilament fiber, sheet film and injection-molded vessel.

16. A process for producing a polyester amide copolymer, comprising subjecting a mixture of an aliphatic polyamide (C) and a monomer of aliphatic polyester (B) successively to:
(1) a first step of reaction at 100-150° C. in the presence of a catalyst while distilling off a low-molecular weight fraction containing water or an alcohol to render the mixture in a substantially uniform state,
(2) a second step of polymerization of the mixture in a uniform molten state at 150-300° C., and
(3) a third step of oligomer removal and higher polymerization at 150-300° C. under a reduced pressure.

17. A process for producing a polyester amide copolymer according to claim 16, wherein a solid polymer once produced through the step (3) is again subjected to a oligomer removal and polymerization step in a molten state in a temperature region of from its melting point to the melting point +150 □ under a reduced pressure.

18. A process for producing a polyester amide copolymer according to claim 16, wherein the aliphatic polyamide (C) is polyamide 6.

19. A process for producing a polyester amide copolymer according to claim 16, wherein the monomer of the aliphatic polyester (B) comprises at last two species selected from the group consisting of an aliphatic dicarboxylic acid or aliphatic dicarboxylic acid ester (D), an aliphatic diol (E) and an alicyclic ester (F).

20. A process for producing a polyester amide copolymer according to claim 19, wherein the monomer of the aliphatic polyester (B) comprises a combination of the aliphatic dicarboxylic acid or aliphatic dicarboxylic acid ester (D) and the aliphatic diol (E).

21. A process for producing a polyester amide copolymer, comprising: holding a mixture of an aliphatic polyamide, an aliphatic polyester which is a ring opening polymer of a cyclic ester, and a cyclic ester or cyclic amide in a heated molten state at a temperature between a melting point of the polyamide and ca. 300° C. to proceed with an ester-amide exchange reaction until a transparent state is assumed, and then proceeding with polycondensation at a lower temperature.

22. A process for producing a polyester amide copolymer according to claim 21, wherein the aliphatic polyamide is polyamide 6, the cyclic ester is ε-caprolactone, and the cyclic amide is ε-caprolactam.
